(19) United States
(12) Patent Application Publication
(10) Pub. No.: US 2014/0158164 A1
(43) Pub. Date: Jun. 12, 2014

(54) CLEANING MACHINE, AND CLEANING METHOD AND CLEANING SYSTEM THEREOF

(71) Applicant: SHENZHEN CHINA STAR OPTOELECTRICS TECHNOLOGY CO.,, Shenzhen, Guangdong (CN)

(72) Inventors: Boyang Ren, Shenzhen (CN); Liang Li, Shenzhen (CN); Chinsheng Ko, Shenzhen (CN)

(73) Assignee: SHENZHEN CHINA STAR OPTOELECTRONICS TECHNOLOGY CO., LTD., Shenzhen, Guangdong (CN)

(21) Appl. No.: 13/813,429

(22) PCT Filed: Dec. 13, 2012
(86) PCT No.: PCT/CN2012/086549

§ 371 Date: Jan. 31, 2013

(30) Foreign Application Priority Data
Dec. 6, 2012 (CN) 201210519691.7

(51) Int. Cl. B08B 3/02

(52) U.S. Cl. CPC B08B 3/02
USPC 134/18; 134/56 R

(57) ABSTRACT

The present disclosure provides a cleaning machine, and a cleaning method and a cleaning system of the cleaning machine. The cleaning method includes: detecting whether the cleaning machine is in a standby mode; and spraying cleaning fluid in a brushing room of the cleaning machine and recycling the sprayed cleaning fluid to form a recycling spraying if the cleaning machine is in the standby mode. The brushing room is independently controlled to spray the cleaning fluid in the brushing room alone. Thus, the spraying frequency of the cleaning fluid in the brushing room is increased, the cleaning fluid can even be continuously sprayed, to improve the wet degree of the brush and further to improve the stability of the cleaning process. Meanwhile the opening frequencies of the air supplying pipes of the cleaning machine are decreased to reduce air consumption.

### BACKGROUND

1. Technical Field

The present disclosure relates to manufacturing technologies of liquid crystal panels, and particularly, to a cleaning machine for cleaning a glass substrate during the manufacturing process of a liquid crystal panel and a cleaning method and a cleaning system of the cleaning machine.

2. Description of Related Art

In the manufacturing process of a liquid crystal panel, a cleaning machine is used for cleaning two glass substrates of the liquid crystal panel. The cleaning machine includes a number of cleaning rooms such as a brushing room, an isolation room, and a heating room, water supplying pipes for supplying cleaning fluid to each cleaning room, and air supplying pipes for supplying dry and clean air to each cleaning room. After the glass substrate enters the brushing room, a water spraying pipe in the brushing room sprays cleaning fluid such as cleaning agent or deionized water to the glass substrate, and a brush is used for brushing the glass substrate to realize the first cleaning of the glass substrate. During the process, the brush presses into the glass substrate for about 0.2˜1.0 mm and the water spraying pipe continuously sprays the cleaning fluid to the contacting surface between the brush and the glass substrate. The cleaning ability of the brush is best when the brush completely gets wet. Since sometimes there are no glass substrates need to be cleaned, the cleaning machine can work in a standby mode. When there are no glass substrates in the cleaning machine, the cleaning machine enters the standby mode, and all the water supplying pipes and air supplying pipes are closed to stop supplying cleaning fluid and dry and clean air.

After the cleaning machine is in the standby mode for a long time, the brush in the brushing room may get dry, and dust may be collected in the air supplying pipes. Thus, at present, when the cleaning machine is in the standby mode, the water supplying pipes and air supplying pipes are opened at intervals to allow the cleaning machine to run at full power, thereby wetting the brush and flushing away the collected dust.

However, if the water supplying pipes and air supplying pipes are opened at a relatively long interval, the brush may become dry and scratch the glass substrate. Additionally, the cleaning ability of the brush may be reduced to affect the stability of the cleaning process. Also, since there are no glass substrates needed to be cleaned, the cleaning fluid flowing into the brushing room is discharged and wasted. Furthermore, extra air may be wasted if the opening frequency of the air supplying pipes configured for cleaning collected dust is kept as high as that of the air supplying pipes.

### SUMMARY

The present disclosure provides a cleaning machine, and a cleaning method and a cleaning system of the cleaning machine, which can reduce cost and improve the stability of the cleaning process.

The cleaning method of a cleaning machine provided in the present disclosure includes: detecting whether the cleaning machine is in a standby mode; and spraying cleaning fluid in a brushing room of the cleaning machine and recycling the sprayed cleaning fluid to form a recycling spraying if the cleaning machine is in the standby mode.

Preferably, the cleaning method further includes the following step before the step of spraying cleaning fluid in a brushing room of the cleaning machine and recycling the sprayed cleaning fluid to form a recycling spraying: closing a discharging valve of the brushing room of the cleaning machine.

Preferably, the cleaning method further includes the following step after the step of spraying cleaning fluid in a brushing room of the cleaning machine and recycling the sprayed cleaning fluid to form a recycling spraying: opening the discharging valve and stopping the recycling spraying of the cleaning fluid in the brushing room after determining that the cleaning machine exits the standby mode.

Preferably, the step of spraying cleaning fluid in a brushing room of the cleaning machine includes: continuously or discontinuously spraying the cleaning fluid in the brushing room of the cleaning machine.

The cleaning system of a cleaning machine provided in the present disclosure includes: a recycling spraying device for spraying cleaning fluid in a brushing room of the cleaning machine and recycling the sprayed cleaning fluid to form a recycling spraying of the cleaning fluid; and a standby module for detecting whether the cleaning machine is in a standby mode and controlling the recycling spraying device to spray the cleaning fluid after determining that the cleaning machine is in the standby mode.

Preferably, the standby module controls the recycling spraying device to continuously or discontinuously spray the cleaning fluid in the brushing room.

Preferably, the standby module includes a detecting unit and a controlling unit, the detecting unit is used for detecting whether the cleaning machine is in the standby mode and sending a detecting result to the controlling unit, and the controlling unit is used for controlling the recycling spraying device to spray the cleaning fluid after receiving the detecting result indicating that the cleaning machine is in the standby mode.

Preferably, the recycling spraying device includes a water storing tank, and a water spraying pipe and a water pumping device communicating with the water storing tank; the water pumping device pumps the cleaning fluid into the water spraying pipe such that the water spraying pipe can spray the cleaning fluid, and the cleaning fluid sprayed out of the water spraying pipe further flows into the water storing tank.

Preferably, the standby module is further used for closing a discharging valve of the brushing room after determining that the cleaning machine is in the standby mode.

Preferably, the standby module opens the discharging valve and closes the recycling spraying device after determining that the cleaning machine exits the standby mode.

Preferably, the standby module is further used for closing a discharging valve of the brushing room after determining that the cleaning machine is in the standby mode, and the discharging valve is arranged in a bottom portion of the water storing tank.

The cleaning machine provided in the present disclosure including a cleaning system, the cleaning system including: a recycling spraying device for spraying cleaning fluid in a brushing room of the cleaning machine and recycling the cleaning fluid to form a recycling spraying of the cleaning fluid; and a standby module for detecting whether the cleaning machine is in a standby mode and controlling the recycling spraying device to spray the cleaning fluid after determining that the cleaning machine is in the standby mode.

Preferably, the standby module controls the recycling spraying device to continuously or discontinuously spray the cleaning fluid in the brushing room.

Preferably, the recycling spraying device includes a water storing tank, and a water spraying pipe and a water pumping pipe communicating with the water storing tank; the water pumping device pumps the cleaning fluid in the water storing tank into the water spraying pipe such that the water spraying pipe can spray the cleaning fluid, and the sprayed cleaning fluid sprayed out of the water spraying pipe flows back to the water storing tank.

Preferably, the standby module is further used for closing the discharging valve after determining that the cleaning machine is in the standby mode.

Preferably, the standby module opens the discharging valve and closes the recycling spraying device after determining that the cleaning machine exits the standby module.

In the cleaning method of the present disclosure, after determining that the cleaning machine is in the standby mode, unlike the cleaning machine of the related art with all the water supplying pipes and air supplying pipes being opened at intervals to supply cleaning agent, deionized water or dry and clean air to all the cleaning rooms, in the present disclosure, the brushing room is independently controlled such that the cleaning fluid is continuously or discontinuously sprayed in the brushing room alone. Thus, the spraying frequency of the cleaning fluid in the brushing room is increased, the cleaning fluid can even be continuously sprayed, to improve the wet degree of the brush and further to improve the stability of the cleaning process. At the same time, the opening frequencies of the air supplying pipes of the cleaning machine are decreased to reduce consumption of air. Furthermore, the sprayed cleaning fluid is recycled to form the recycling spraying, which allows the cleaning fluid to be recycled in the brushing room, and avoids the waste of the cleaning fluid and thus reduces the cost.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a flow chart of a cleaning method in accordance with a first embodiment of the present disclosure;

FIG. 2 is a flow chart of a cleaning method in accordance with a second embodiment of the present disclosure;

FIG. 3 is a schematic view of a cleaning system in accordance with a first embodiment of the present disclosure;

FIG. 4 is a schematic view of a standby module of FIG. 3; and

FIG. 5 is a schematic view of a recycling spraying device of FIG. 3.

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

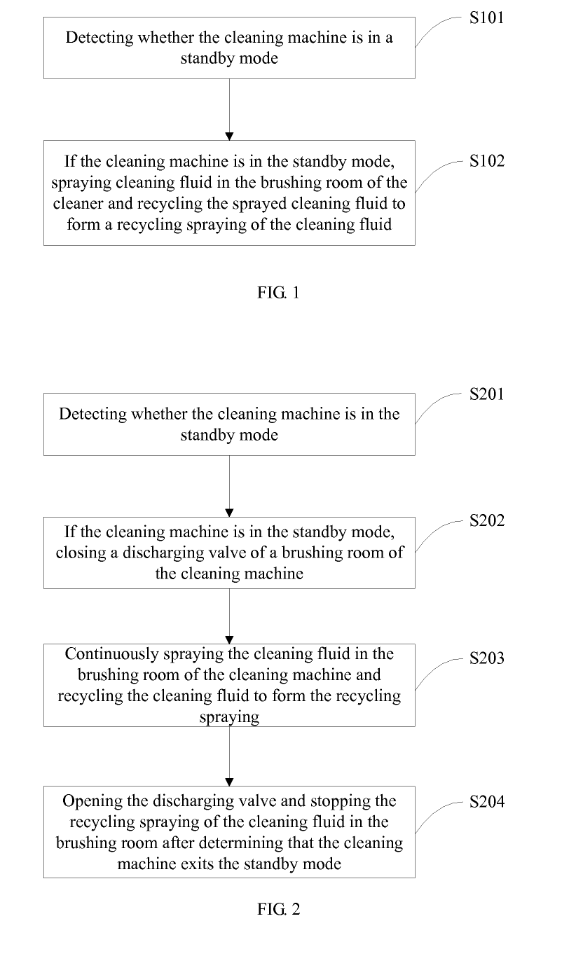

Referring to FIG. 1, which is a flow chart of a cleaning method in accordance with a first embodiment of the present disclosure, the cleaning method includes the following steps.

Step S101, detecting whether the cleaning machine is in a standby mode.

At the beginning of the cleaning process of a glass substrate, the glass substrate enters the cleaning machine through an opening and is inclined from a horizontal state (the inclined angle is about 5 degrees). After that, the glass substrate enters an ultraviolet room where the glass substrate is irradiated by ultraviolet light to dissolve organic substances on the surface of the glass substrate. The glass substrate then enters an isolation room (for isolating a dry process and a wet process); a water spraying pipe in the isolation room sprays cleaning fluid such as cleaning agent or deionized water to the glass substrate, and a brush starts brushing the glass substrate to brush away large stain particles (>5 um) on the surface of the glass substrate, which realizes the first cleaning of the glass substrate. Next, the glass substrate enters a spraying room where water is sprayed towards the large stain particles and cleaning agent, thereby washing away the large stain particles. After that, the glass substrate enters a fine cleaning room where the mixture of high-pressure air and cleaning fluid or ultrasound is used to wash away small stain particles (<5 um) on the glass substrate. The glass substrate then enters a final cleaning room to be finally cleaned by using clean deionized water. At this point, the wet process is finished and the glass substrate next enters a baking room such that a pneumatic cutter is used to dry the water on the surface of the glass substrate. The glass substrate then enters a heating room to be heated to an appropriate temperature. Finally, the glass substrate is kept horizontal from the inclined state and is transferred out of the cleaning room to finish the cleaning process of the glass substrate.

During the process, the water supplying pipes and air supplying pipes continuously supply cleaning agent or dry and clean air to each cleaning room, and the cleaning agent flows to the cleaning rooms corresponding to the later processes from the cleaning rooms corresponding to the earlier processes, and finally is discharged out of the cleaning machine from the brushing room. For example, the deionized water at first flows into the fine cleaning room to wash away the small stain particles on the glass substrate; then the used deionized water flows into the spraying room corresponding to an earlier process to wash away the large stain particles or cleaning agent; after that, the deionized water flows into the brushing room to brush away the large stain particles on the surface of the glass substrate, thereby realizing the first cleaning of the glass substrate; and the deionized water is discharged out of the brushing room.

When there are no glass substrates in the cleaning machine needed to be cleaned, in order to save energy, the cleaning machine enters the standby mode, and all the water supplying pipes and air supplying pipes are closed to stop supplying cleaning agent, deionized water or dry and clean air to each cleaning room, therefore, it is necessary to detect whether the cleaning machine is in the standby mode.

Step S102, if the cleaning machine is in the standby mode, spraying cleaning fluid in the brushing room of the cleaning machine and recycling the sprayed cleaning fluid to form a recycling spraying.

In order to prevent the brush arranged in the brushing room for brushing the glass substrate from becoming dry and scratching the glass substrate and further affecting the product quality and the cleaning ability thereof, when the cleaning machine is in the standby mode, cleaning fluid such as cleaning agent or deionized water is required to be sprayed to the brush to keep the brush wet. Unlike the cleaning machine of the related art with all the water supplying pipes and air supplying pipes being opened at intervals to supply cleaning agent, deionized water or dry and clean air to all the cleaning rooms, in the present disclosure, the brushing room is independently controlled such that the cleaning fluid is continuously or discontinuously sprayed in the brushing room alone, and the sprayed cleaning fluid is recycled to form the recycling spraying.

In the embodiment, a recycling spraying device is used for realizing the recycling spraying of the cleaning fluid. The recycling spraying device includes a water storing tank, a water spraying pipe and a water pumping device communicating with the water storing tank. The water pumping device pumps the cleaning fluid in the water storing tank into the water spraying pipe so that the water spraying pipe can spray the cleaning fluid. The cleaning fluid sprayed out of the water spraying pipe then is recycled and flows into the water storing tank, which allows the cleaning fluid to be recycled and form the recycling spraying in the brushing room.

Thus, the spraying frequency of the cleaning fluid in the brushing room is increased, the cleaning fluid can even be continuously sprayed, to improve the wet degree of the brush and further to improve the stability of the cleaning process. At the same time, the opening frequencies of the air supplying pipes of the cleaning machine are decreased to reduce consumption of air. Furthermore, the sprayed cleaning fluid is recycled to form the recycling spraying, which allows the cleaning fluid to be recycled in the brushing room, and avoids the waste of the cleaning fluid and thus reduces the cost.

Referring to FIG. 2, which is a flow chart of a cleaning method of a cleaning machine in accordance with a second embodiment of the present disclosure, the cleaning method includes the following steps.

Step S201, detecting whether the cleaning machine is in the standby mode.

When there are no glass substrates in the cleaning machine needed to be cleaned, in order to save energy, the cleaning machine enters the standby mode, and all the water supplying pipes and air supplying pipes are closed to stop supplying cleaning agent, deionized water or dry and clean air to each cleaning room, therefore, it is necessary to detect whether the cleaning machine is in the standby mode.

Step S202, if the cleaning machine is in the standby mode, closing a discharging valve of a brushing room of the cleaning machine.

When the cleaning machine cleans the glass substrate, the discharging valve is opened to discharge the used cleaning fluid. If the cleaning machine is detected to be in the standby mode, it indicates that there are no glass substrates in the cleaning machine, thus, the discharging valve is closed to stop discharging the cleaning fluid and recycle the cleaning fluid.

Step S203, continuously spraying the cleaning fluid in the brushing room of the cleaning machine and recycling the cleaning fluid to form the recycling spraying.

In the step S203, the discharging valve is closed and the cleaning fluid in the recycling spraying device cannot be discharged out of the recycling spraying device, thus, the cleaning fluid can be continuously sprayed to keep the brush wet. In this way, the risk that the brush may become dry is eliminated, the wet degree of the brush is improved, and the stability of the cleaning process is improved.

The above discharging valve can be arranged in a bottom portion of the water storing tank. When the cleaning machine cleans the glass substrate normally, the used cleaning fluid is discharged out of the brushing room through the water storing tank, which is convenient. After the cleaning machine is detected to be in the standby mode, the discharging valve is closed and the left cleaning fluid is stored in the watering storing tank, which allows the recycling spraying device to recycle the cleaning fluid in the brushing room to wet the brush. Therefore, the present cleaning fluid in the water storing tank is used to realize the recycling spraying of the cleaning fluid without requiring for extra cleaning fluid, which not only eases the discharge of the cleaning fluid, but also reduces the cost by making full use of the present cleaning fluid.

In the embodiment, the discharging valve is closed to prevent the cleaning fluid from being discharged and wasted. Actually, when the discharging valve is higher than the water storing tank, the cleaning fluid is allowed to be discharged through the discharging valve when running over the water storing tank. At this state, in the recycling spraying, the amount of cleaning fluid discharged out of the brushing room through the discharging valve is small, thus, the discharging valve can be kept opened. However, in this state, a discharging opening is required to be formed in the water storing tank so that the cleaning fluid in the water storing tank can be replaced from time to time. Thus, in a preferred embodiment, the discharging valve is formed in the water storing tank, especially in the bottom portion of the water storing tank, and is closed after the cleaning machine enters the standby mode.

Step S204, opening the discharging valve and stopping the recycling spraying of the cleaning fluid in the brushing room after determining that the cleaning machine exits the standby mode.

If the cleaning machine is detected to exit the standby mode, the cleaning machine begins to clean the glass substrate, and the air supplying pipes and water supplying pipes are opened such that the water supplying pipes can supply cleaning fluid to the brushing room to clean the glass substrate, thereby stopping the recycling spraying of the cleaning fluid. Also, the discharging valve is opened to discharge the cleaning fluid. Since the cleaning fluid is continuously sprayed in the brushing room when the cleaning machine is in the standby mode, thus, the brush is kept wet to improve the cleaning effect and avoid scratching of the glass substrate.

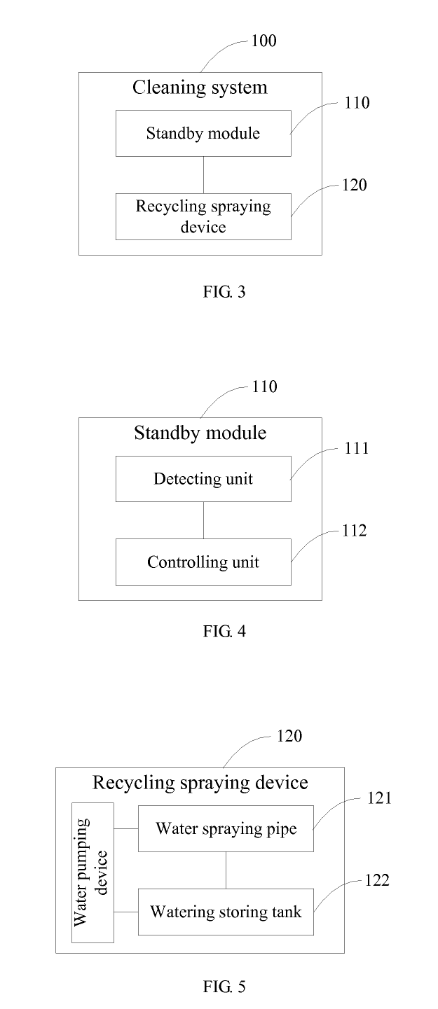

Referring to FIGS. 3 to 5, the present disclosure further provides a cleaning system. The cleaning system 100 includes a standby module 110 and a recycling spraying device 120. The standby module 110 is used for detecting whether the cleaning machine is in the standby mode. The standby module 110 controls the recycling spraying device 120 to spray the cleaning fluid after determining that the cleaning machine is in the standby mode. The standby module 110 includes a detecting unit 111 and a controlling unit 112. The detecting unit 111 is used for detecting whether the cleaning machine is in the standby mode in real time and sending a detecting result to the controlling unit 112. The controlling unit 112 receives the detecting result indicating that the cleaning machine is in the standby mode and in response controls the recycling spraying device 120 to spray the cleaning fluid. After the cleaning machine exits the standby mode, the controlling unit 112 closes the recycling spraying device 120.

For example, if there are no glass substrates in the cleaning machine for a predetermined time interval, the cleaning machine enters the standby mode. The detecting unit 111 begins to detect whether the cleaning machine is in the standby mode and sends the detecting result to the controlling unit 112. The controlling unit 112 receives the detecting result and in response controls the recycling spraying device 120 to continuously or discontinuously spray the cleaning fluid. After the cleaning machine exits the standby mode, the detecting unit 111 sends the detecting result indicating that the cleaning machine exits the standby mode to the controlling unit 112, and the controlling unit 112 in response closes the recycling spraying device 120.

The recycling spraying device 120 is used for continuously or discontinuously spraying the cleaning fluid in the brushing room of the cleaning machine and for recycling the sprayed cleaning fluid to form the recycling spraying. The recycling spraying device 120 is arranged in the brushing room, including a water storing tank 122, a water spraying pipe 121 and a water pumping device 123 communicating with the water storing tank 122. The water pumping device 123 pumps the cleaning fluid in the water storing tank 122 into the water spraying pipe 121 to allow the water spraying pipe 121 to spray the cleaning fluid.

Furthermore, the standby module 110 is further used for closing the discharging valve of the brushing room after determining that the cleaning machine is in the standby mode, and opening the discharging valve and closing the recycling spraying device after the cleaning machine exits the standby mode. When the cleaning machine cleans the glass substrate, the discharging valve is opened to discharge the wasted cleaning fluid. After the cleaning machine enters the standby mode, there are no glass substrates in the cleaning machine, thus, the controlling unit 112 of the standby module 110 closes the discharging valve to stop discharging the cleaning fluid. Thus, the cleaning fluid in the recycling spraying device 120 can be prevented from being discharged and wasted. Also, the cleaning fluid can be sprayed continuously to keep the brush wet, which eliminates the risk that the brush may become dry, improves the wet degree of the brush, and further improves the stability of the cleaning process.

Furthermore, the above discharging valve can be arranged in a bottom portion of the water storing tank. When the cleaning machine cleans the glass substrate normally, the used cleaning fluid is discharged out of the brushing room through the water storing tank, which is convenient. After the cleaning machine is detected to be in the standby mode, the discharging valve is closed and the left cleaning fluid is stored in the watering storing tank, which allows the recycling spraying device to recycle the cleaning fluid in the brushing room to wet the brush. Therefore, the present cleaning fluid can be used to form the recycling spraying of the cleaning fluid without requiring for extra cleaning fluid, which not only eases the discharge of the cleaning fluid, but also reduces the cost by making full use of the present cleaning fluid.

In the embodiment, the discharging valve is closed to prevent the cleaning fluid from being discharged and wasted. Actually, when the discharging valve is higher than the water storing tank, the cleaning fluid is allowed to be discharged through the discharging valve when running over the water storing tank. At this state, in the recycling spraying, the amount of cleaning fluid discharged out of the brushing room through the discharging valve is small, thus, the discharging valve can be kept opened. However, in this state, a discharging opening is required to be formed in the water storing tank so that the cleaning fluid in the water storing tank can be replaced from time to time. Thus, in a preferred embodiment, the discharging valve is arranged in the water storing tank, especially in the bottom portion of the water storing tank, and the discharging valve is closed when the cleaning machine enters the standby mode.

The present disclosure further provides a cleaning machine which includes a cleaning system. The cleaning system includes a recycling spraying device and a standby module. The recycling spraying device is used for spraying cleaning fluid in a brushing room of the cleaning machine and recycling the sprayed cleaning fluid to form a recycling spraying. The standby module is used for detecting whether the cleaning machine is in the standby mode and controlling the recycling spraying device to spray the cleaning fluid if the cleaning machine is in the standby mode. The cleaning system in the embodiment can be referred to that of the above embodiments, which is not given in detail here.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. A cleaning method of a cleaning machine, comprising:
detecting whether the cleaning machine is in a standby mode; and
spraying cleaning fluid in a brushing room of the cleaning machine and recycling the sprayed cleaning fluid to form a recycling spraying if the cleaning machine is in the standby mode.

2. The cleaning method of claim 1 further comprising the following step before the step of spraying cleaning fluid in a brushing room of the cleaning machine and recycling the sprayed cleaning fluid to form a recycling spraying:
closing a discharging valve of the brushing room of the cleaning machine.

3. The cleaning method of claim 2 further comprising the following step after the step of spraying cleaning fluid in a brushing room of the cleaning machine and recycling the sprayed cleaning fluid to form a recycling spraying:
opening the discharging valve and stopping the recycling spraying of the cleaning fluid in the brushing room after determining that the cleaning machine exits the standby mode.

4. The cleaning method of claim 1, wherein the step of spraying cleaning fluid in a brushing room of the cleaning machine comprises:
continuously or discontinuously spraying the cleaning fluid in the brushing room of the cleaning machine.

5. The cleaning method of claim 2, wherein the step of spraying cleaning fluid in a brushing room of the cleaning machine comprises:
continuously or discontinuously spraying the cleaning fluid in the brushing room of the cleaning machine.

6. A cleaning system of a cleaning machine, comprising:
a recycling spraying device for spraying cleaning fluid in a brushing room of the cleaning machine and recycling the sprayed cleaning fluid to form a recycling spraying of the cleaning fluid; and
a standby module for detecting whether the cleaning machine is in a standby mode and controlling the recycling spraying device to spray the cleaning fluid after determining that the cleaning machine is in the standby mode.

7. The cleaning system of claim 6, wherein the standby module controls the recycling spraying device to continuously or discontinuously spray the cleaning fluid in the brushing room.

8. The cleaning system of claim 6, wherein the standby module comprises a detecting unit and a controlling unit, the detecting unit is used for detecting whether the cleaning machine is in the standby mode and sending a detecting result to the controlling unit, and the controlling unit is used for controlling the recycling spraying device to spray the cleaning fluid after receiving the detecting result indicating that the cleaning machine is in the standby mode.

9. The cleaning system of claim 6, wherein the recycling spraying device comprises a water storing tank, and a water spraying pipe and a water pumping device communicating with the water storing tank; the water pumping device pumps the cleaning fluid into the water spraying pipe such that the water spraying pipe can spray the cleaning fluid, and the cleaning fluid sprayed out of the water spraying pipe further flows into the water storing tank.

10. The cleaning system of claim 6, wherein the standby module is further used for closing a discharging valve of the brushing room after determining that the cleaning machine is in the standby mode.

11. The cleaning system of claim 10, wherein the standby module opens the discharging valve and closes the recycling spraying device after determining that the cleaning machine exits the standby mode.

12. The cleaning system of claim 9, wherein the standby module is further used for closing a discharging valve of the brushing room after determining that the cleaning machine is in the standby mode, and the discharging valve is arranged in a bottom portion of the water storing tank.

13. A cleaning machine, comprising a cleaning system, the cleaning system comprising:
a recycling spraying device for spraying cleaning fluid in a brushing room of the cleaning machine and recycling the cleaning fluid to form a recycling spraying of the cleaning fluid; and
a standby module for detecting whether the cleaning machine is in a standby mode and controlling the recycling spraying device to spray the cleaning fluid after determining that the cleaning machine is in the standby mode.

14. The cleaning machine as claimed in claim 13, wherein the standby module controls the recycling spraying device to continuously or discontinuously spray the cleaning fluid in the brushing room.

15. The cleaning machine as claimed in claim 13, wherein the recycling spraying device comprises a water storing tank, and a water spraying pipe and a water pumping pipe communicating with the water storing tank; the water pumping device pumps the cleaning fluid in the water storing tank into the water spraying pipe such that the water spraying pipe can spray the cleaning fluid, and the sprayed cleaning fluid sprayed out of the water spraying pipe flows back to the water storing tank.

16. The cleaning machine as claimed in claim 13, wherein the standby module is further used for closing the discharging valve after determining that the cleaning machine is in the standby mode.

17. The cleaning machine as claimed in claim 16, wherein the standby module opens the discharging valve and closes the recycling spraying device after determining that the cleaning machine exits the standby module.
